(19) United States
(12) Patent Application Publication
(10) Pub. No.: US 2016/0267115 A1
(43) Pub. Date: Sep. 15, 2016

(54) Methods and Systems for Common Key Services

(71) Applicant: Michigan Health Information Network - MiHN, East Lansing, MI (US)

(72) Inventors: Tim Pletcher, East Lansing, MI (US); Jeff Livesay, Pinckney, MI (US); Shelley Mannino, Grand Ledge, MI (US); Rod Mach, Northville, MI (US); Rick Wilkening, Ann Arbor, MI (US)

(21) Appl. No.: 14/643,910

(22) Filed: Mar. 10, 2015

(51) Int. Cl. G06F 17/30; G06F 19/00

(52) U.S. Cl. CPC G06F 17/30321; G06F 17/30631; G06F 17/30318; G06F 17/30365; G06F 19/322

(57) ABSTRACT

An illustrative method according to a set of instructions stored on the memory of a computing device includes receiving from a data sharing organization device a request to obtain or update a record associated with an individual. The method further includes determining a match in a master person index between the individual and an identity of the individual stored in the master person index. The method further includes determining that a common key identifier unique to the individual does not exist. The method further includes generating the common key identifier and sending the common key identifier to the master person index such that the common key identifier is stored in the master person index and associated with the identity of the individual stored in the master person index. The method further includes sending the common key identifier unique to the identifier to the data sharing organization device.

### BACKGROUND

Record keeping is widely practiced throughout the world. Record keeping can be used in many various industries and for many various purposes. For example, record keeping may be utilized in industries such as health care, banking, finance, retail, services, or any other industry. Records can take various forms including, but not limited to, financial statements, receipts, medical records, legal documents, insurance records, employment records, payroll records, confidential records, e-mail, website content, forms of identification, etc. Records may also be kept or stored in various ways. For example, records may be stored physically in files or electronically on cloud storages, document management systems, secure servers, hard drives, etc.

In just one example, records are utilized in the health care industry for various purposes. For example, a physician may keep records relating to appointments for patients, patient demographic information, and/or records of patient visits including vitals, diagnoses, and treatments. Such records may be used to generate billing information for the patient, an insurance provider of the patient, or another third party payee such as a government agency. Such billing information may also be kept as records by the physician.

Records are important to many individuals, businesses, and governments. Accordingly, records are the subject of much attention with regards to how records are identified, classified, prioritized, stored, secured, archived, preserved, retrieved, tracked, and destroyed. Decisions regarding records are made based on many different factors including applicable laws, company policies, expected future utilization of a record, type of record, importance/value of record, etc.

### SUMMARY

An illustrative method according to a set of instructions stored on the memory of a computing device includes receiving from a data sharing organization device, by a processor of the computing device, a request to obtain or update a record associated with an individual. The method further includes determining, by the processor, a match in a master person index between the individual and an identity of the individual stored in the master person index. The method further includes determining, by the processor, that a common key identifier unique to the individual does not exist. The method further includes generating, by the processor, the common key identifier. The method further includes sending, by the processor, the common key identifier to the master person index such that the common key identifier is stored in the master person index and associated with the identity of the individual stored in the master person index. The method further includes sending, by the processor, the common key identifier unique to the identifier to the data sharing organization device.

An illustrative non-transitory computer readable medium having instructions stored thereon that, upon execution by a computing device, cause the computing device to perform operations, wherein the instructions include instructions to receive from a data sharing organization device a request to obtain or update a record associated with an individual. The instructions further include instructions to determine a match in a master person index between the individual and an identity of the individual stored in the master person index. The instructions further include instructions to determine that a common key identifier unique to the individual does not exist. The instructions further include instructions to generate the common key identifier. The instructions further include instructions to send the common key identifier to the master person index such that the common key identifier is stored in the master person index and associated with the identity of the individual stored in the master person index. The instructions further include instructions to send the common key identifier unique to the identifier to the data sharing organization device.

An illustrative apparatus includes a memory, a processor coupled to the memory, and a first set of instructions stored on the memory and configured to be executed by the processor. The processor is configured to receive from a data sharing organization device, a request to obtain or update a record associated with an individual. The processor is further configured to determine a match in a master person index between the individual and an identity of the individual stored in the master person index. The processor is further configured to determine that a common key identifier unique to the individual does not exist. The processor is further configured to generate the common key identifier. The processor is further configured to send the common key identifier to the master person index such that the common key identifier is stored in the master person index and associated with the identity of the individual stored in the master person index. The processor is further configured to send the common key identifier unique to the identifier to the data sharing organization device.

### BRIEF DESCRIPTION OF THE DRAWINGS

Illustrative embodiments will hereafter be described with reference to the accompanying drawings.

FIG. 1 is a flow diagram illustrating a method for generating a common key for known persons in accordance with an illustrative embodiment.

FIG. 2 is a flow diagram illustrating a method for generating a common key for unknown persons in accordance with an illustrative embodiment.

FIG. 3 is a flow diagram illustrating a method for utilizing a known common key for a known person in accordance with an illustrative embodiment.

FIG. 4 is a flow diagram illustrating a method for acquiring records using a common key in accordance with an illustrative embodiment.

FIG. 5 is a flow diagram illustrating a method for verifying potential person matches in accordance with an illustrative embodiment.

FIG. 6 is a flow diagram illustrating a method for updating files using a common key service in accordance with an illustrative embodiment.

FIG. 7 is a flow diagram illustrating a method for utilizing a common key service in conjunction with a patient's hospital visit in accordance with an illustrative embodiment.

FIG. 8 is a block diagram illustrating an example computer in accordance with an illustrative embodiment.

FIG. 9 is a flow diagram illustrating a method for utilizing a common key service in accordance with an illustrative embodiment.

### DETAILED DESCRIPTION

Disclosed herein are systems and methods, which can be realized in software, hardware, or a combination thereof, to utilize and generate common keys in a common key service. A common key provides a way to match persons and their records across multiple organizations, applications, and services. In this way full and complete records for an individual can be accessed or modified as desired. Even if multiple records are associated with an individual, the common key can link the various records together. The methods and systems disclosed herein also provide for a common key service that is safe and secure, protects confidentiality, and has high accuracy and data integrity of records shared across the multiple entities.

In an illustrative embodiment, exchange of information between health care entities may be performed utilizing common key services. Each individual patient is matched to a single identity, and that identity is assigned a unique common key. The common key may be an alphanumeric sequence. The common key is unique to each patient, and is used to link records stored, housed, and/or generated by multiple health care entities.

The common key, when associated with the single identity of each individual patient, can be used to associate the records of that patient across multiple entities and data stores across the healthcare market, such as primary care physician records, specialist records, hospital records, demographic records, billing information records, insurance information records, medical history records, care coordinator records, research databases, oncological databases, behavioral health system databases, pharmacy databases, etc.

Advantageously, a common key service can be used to link patients to their respective electronic medical records. Records may come from various formats and be stored across disparate systems. A common key can be used to link various records of a patient together. Additionally, a patient's demographic information may change over time (e.g., address, name, billing information), making demographic information outdated or subject to error. By using a common key to keep track of records, complications and errors in treating patients due to incomplete information and records may be reduced.

A common key service can minimize mismatched record/patient associations and ensure that the record keeping is accurate. Matches and links between an individual and their records can be effected across multiple organizations, applications, and services. This can lead to higher data integrity, which in turn improves patient safety by minimizing mistakes made by those utilizing the data. For example, the common key services may provide enhanced patient safety and care coordination by ensuring that medication and allergy information is tied to the correct person through a continuum of care, enhancing patient safety and potentially reducing the risk of medical errors. A common key service can also reduce work completed to coordinate care to patients across different organizations, applications, and services. This can also reduce cost of record keeping in service industries, such as health care. Furthermore, a common key service as disclosed herein may be implemented to utilize current health information exchanges (HIE) and healthcare information technology (HIT) systems.

In an illustrative embodiment, any HIT or HIE endpoint may be mapped to a master person index using the common key services. For example, a governmental body such as a state government may maintain a master person index (MPI). The MPI may contain (or have the aim of containing) a record of every person in the state or known to the state. Such an MPI may be populated using information acquired through different government entities, such as entities that issue identification, process taxes, process health benefits, or schools. The common key service can insure that any medical records are mapped to a single identity of an individual as maintained on the MPI. In one illustrative embodiment, the systems and methods disclosed herein for a common key service may be executed as a web service that utilizes API calls to the MPI and/or HITs and HIEs. Such an embodiment may allow for easy integration of an MPI, HIT, and/or HIE with the common key service.

In one illustrative embodiment, the common key system may be used in a case that tracks an active care relationship of a provider or providers with a patient in the healthcare industry. For example, a Patient X is admitted to a hospital. The hospital may be a part of a data sharing organization (DSO). Such a (DSO) may include other health care providers or hospitals that are a part of a single health system. A provider, such as a physician, at the hospital may generate an admit-discharge-transfer (ADT) notification that indicates Patient X has been admitted to the hospital. The ADT notification may be sent to an active care relationship record via the DSO that invokes the common key service. In other words, when the DSO attempts to store the ADT notification, the active care relationship service (which may be offered separately from or in conjunction with the common key service) will invoke or reference a common key from the common key service to determine and/or verify that the ADT notification is properly associated with and stored properly. That is, the system invokes the common key service to ensure that the ADT notification is associated with the correct person.

The common key service then utilizes demographic information received in conjunction with the ADT notification to search a master person index (MPI) for the identity of the patient admitted to the hospital. The MPI may be maintained by a state agency, as indicated above, or may be stored and maintained by another entity, such as the entity offering the common key service. If a match for the patient is found in the MPI and the patient is already associated with a common key, the MPI sends back to the common key service that patient's unique common key. In this way, the ADT notification can be properly recorded and associated with the true identity of the patient in the active care relationship files. Similarly, the common key may also be used by the DSO and the active care relationship service to determine other records relating to the Patient X, which may facilitate proper care to the Patient X while they are treated at the hospital.

If the MPI finds a true identity of Patient X based on the demographic information, but the Patient X is not yet associated with a unique common key, the MPI will request a common key from the common key service. A common key is generated by the common key service and that common key is assigned to the Patient X. Similar to the above, the common key can then be added to the appropriate records.

If the MPI does not find an identity match for Patient X or a common key, the MPI can create a new person record and request a new unique common key from the common key service. Examples of persons that may not have a record or common key may be a newborn or a person that has no previous affiliation with the body maintaining the MPI.

In another example, the Patient X may be admitted to a hospital and the DSO associated with the hospital may already be aware of a common key associated with the Patient X. Accordingly, when an ADT notification is generated, the DSO may send the ADT notification to the active care relationship service as well as the common key service along with the known common key. Accordingly, the records may be stored and associated with the common key, and the common key service may not have to look up the common key and match an identity in the MPI. However, in an alternative embodiment, the common key service may still look up the common key and the identity of Patient X in the MPI so as to verify that all of the information from the DSO is correct.

In another illustrative embodiment, the common key service may be utilized to anonymize and make records more secure and private. For example, after a common key has been established for a patient and known by DSOs, health care providers, an MPI, the common key service, etc., personal identifying information about the patient may no longer be transmitted between those various entities. For example, a patient's records may be updated using only the patient's common key to identify which records to update, and the patient's name, birthdate, social security number, address, other demographic data, etc. may not be used to update the patient's medical records. In this way, the transmission of the patient's medical records and the medical records themselves may be de-identified.

In another illustrative embodiment, a different use case may be applied in conjunction with a common key service. In the embodiment, a researcher may be studying a medical condition and utilizing records to perform a study. For example, the researcher may be studying the effectiveness of depression treatment as a cancer patient progresses through chemotherapy. Different treatments for a cancer patient may be administered by multiple providers for a single patient. Records for the different treatment may be generated and/or stored on multiple different systems. Accordingly, locating accurate information across disparate systems for a single patient may be difficult. For example, the name John Smith is very common, and if he is a subject of the study, linking together different medical records with various medical records numbers may be difficult. In other words, the researcher may find it difficult to piece together exactly which John Smith got what treatments, when the treatments were administered, and where the treatments were administered because, in part, each system may utilize different medical record numbers for the various John Smiths that exist.

Accordingly, the researcher may utilize the common key system to determine which of the various records relating to a John Smith related to the John Smith that is the subject of the study. In this way, the research can be more easily and accurately conducted. In one embodiment, the records may not be associated with a common key, so the common key service matches each record to a true identity associated with the John Smith that is the subject to the study. In another embodiment, the researcher may find records that are already associated with a common key. In this instance, the researcher may utilize the common key service to request the common key of the John Smith that is the subject of the study. Once the common key for the correct John Smith is determined, the records that include the same common key may be easily identified, either by the researcher or automatically by the common key service. In other words, this embodiment allows researchers to link information from various systems to the appropriate patients using the common key services.

The common key services systems and methods disclosed herein overcomes difficulties in matching patients to facilitate the exchange of health information, despite medical information being stored in disparate systems. For example, one hospital registration/admission system may record gender as Male, Female, Unknown, while another hospital system may list M, F, or U instead. Furthermore, inconsistencies in patient demographics may also complicate accurate matching. For example, a patient's name may be entered as Jane Smith-Jones in one system; Jane Smith Jones (without the hyphenation (-)) in another system; and a third system may record her name as Jane Jones. In one system, Jane's address may be her most recent, while another system still has her address as her previous home; one may have her date of birth with year 1975 while the others have her birth year as 1957. In an illustrative embodiment, when a provider or data sharing organization requests records for a particular patient (or records associated with a particular common key), the system may format records according to the way the requesting party stores and transmits patient data and records. In this way, a requesting party may more easily interpret, display, and store the requested information according to the requesting party's system.

To streamline the exchange of information to support meaningful use and accountable care, electronic health care systems utilize reliable matching using a common key service as disclosed herein to determine that the right information is attributed to the right patient every time.

The common key services disclosed herein provide a consistent and reliable way to match patients across multiple organizations, applications and services. Such reliable matching capabilities ensure patient safety and high data integrity when data is shared. The common key service links information for individuals or organizations by using best practices for matching criteria to ensure that identifiers and attributes positively and accurately identify multiple types of entities. Examples of attributes that may be used to match identities include demographic information such as name, date of birth, gender, etc. In an alternative embodiment, information unique to the patient such as biometric information (fingerprint, palm scan, eye scan, etc.) may be used to determine an identity match. Individuals and entities that may use a common key service may include patients, beneficiaries, physicians and physician organizations, payers and health plans, hospitals and health systems, health care facilities, public health entities, etc. The common key services disclosed herein may allow accurate data sharing through a wide variety of use cases, such as results delivery, hospital notifications, public health reporting, care coordination and patient safety, quality and administrative reporting, patient engagement, infrastructure (e.g. active care relationship service, statewide health provider directory, information security/identity management), standard consent, quality assurance systems, etc.

The common key service disclosed herein provides the means to link information for individuals or organizations accurately in support of various use cases. For example, improved patient matching increases the volume of outbound admission-discharge-transfer (ADT) messages that accurately reach providers and payers, which helps a widespread health system operate more efficiently. The common key systems and methods disclosed herein may also leverage a state's master person index (MPI) which may utilize robust processes for managing information about persons and de-duplicating entries with great accuracy.

In an illustrative embodiment, the common key service receives a request for a patient's common key and passes the request to a respective state's MPI. Such a request may result in the following actions: (1) If the patient is found in the MPI, then the common key service creates a common key for the patient and cross-references it with the state's MPI to ensure accurate mapping across systems. (2) If a person is not found in the state's MPI, then the common key service assigns a common key and passes it to the state's MPI, which creates or modifies a record for that patient in the MPI. (3) If a potential match or possible duplicate is identified in the state's MPI the requestor receives a list of possible matches and is prompted to review the records in detail to identify the correct patient and/or to identify errors that caused the duplication in the MPI (e.g., misspelled name, incorrect birth date). The requestor then sends a message to the common key service which informs the MPI as to which of the duplicates is the right person. If the MPI is the source for the duplicate data, an MPI staff may review the data and correct duplicates and errors. Such a process may help ensure that person records are kept up-to-date, improving the integrity of the common key service and making both the MPI and common key service more robust. A record may be modified or created in the MPI by sending a message from the common key service that includes an action and any associated common keys. For example, the action in a message may be one or more of merge, update, or delete. Common keys to merge, update, or delete would be include in the message and associated with the appropriate action in the message.

Additionally, the common key service may utilize an active care relationship service (ACRS). An ACRS or similar records management system may be exposed to the common key service via an application programming interface (API) and then mapped to and integrated with the MPI using its APIs. This may yield an ease of technical implementation. For example, a Medicaid population that is serviced using an ACRS may be easily applied and used with a common key service.

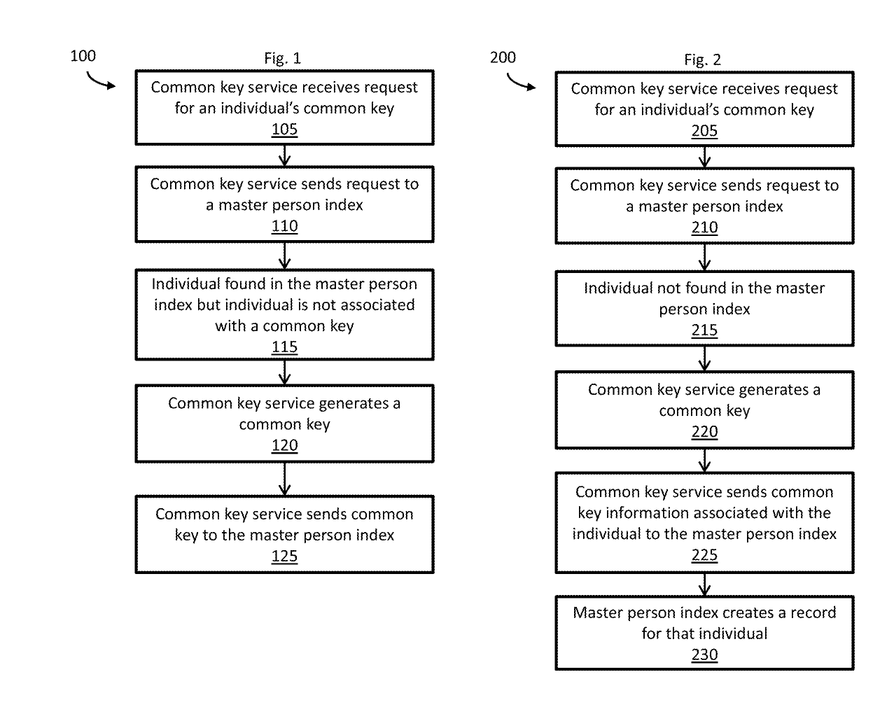

FIG. 1 is a flow diagram illustrating a method 100 for generating a common key for known persons in accordance with an illustrative embodiment. In alternative embodiments, fewer, additional, and/or different operations may be performed. Also, the use of a flow diagram is not meant to be limiting with respect to the order of operations performed. In an operation 105, a common key service receives a request for an individual's common key.

In an operation 110, the common key service sends a request to a master person index (MPI). In an alternative embodiment, the MPI may instead be any database that stores information on persons and de-duplicates records on individual persons. In an operation 115, the MPI finds the individual in the MPI, but the individual is not associated with a common key. In an operation 120, the common key service generates a common key. In an operation 125, the common key service sends the common key to the MPI, such that the MPI may associate the common key with the record of the individual in the MPI. In an alternative embodiment, the MPI and the common key service may not be separate systems. In other words, the common key system may store persons similar to an MPI, may determine the person matches in the MPI according to requests from data sharing organization devices or providers, and may use the common keys to de-duplicate records regarding single individuals. In other words, the common key system and the MPI may be the same or multiple systems that achieve the same functions as disclosed herein.

FIG. 2 is a flow diagram illustrating a method 200 for generating a common key for unknown persons in accordance with an illustrative embodiment. In alternative embodiments, fewer, additional, and/or different operations may be performed. Also, the use of a flow diagram is not meant to be limiting with respect to the order of operations performed. In an operation 205, a common key service receives a request for an individual's common key.

In an operation 210, the common key service sends a request to a master person index (MPI). In an operation 215, the MPI does not find the individual in the master person index. In an operation 220, the common key service generates a common key for the individual in response to the MPI not finding a record of the individual in the MPI.

In an operation 225, the common key service sends the generated common key information associated with the individual to the MPI. In an operation 230, the MPI creates a record for that individual that includes identifying demographic information and the common key.

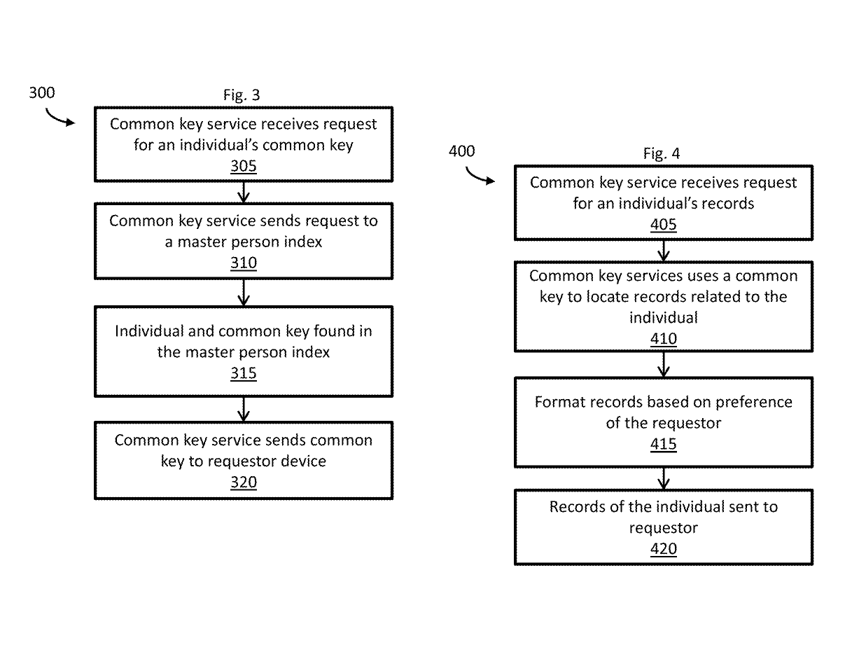

FIG. 3 is a flow diagram illustrating a method 300 for utilizing a known common key for a known person in accordance with an illustrative embodiment. In alternative embodiments, fewer, additional, and/or different operations may be performed. Also, the use of a flow diagram is not meant to be limiting with respect to the order of operations performed. In an operation 305, a common key service receives a request for an individual's common key.

In an operation 310, the common key service sends a request to a master person index (MPI). In an operation 315, the MPI finds the individual and an associated common key in the MPI. In an operation 320, the common key service sends the common key received from the MPI to the requestor device. Additionally, in another embodiment, the common key service may also associate a record from the requestor with the common key.

FIG. 4 is a flow diagram illustrating a method 400 for acquiring records using a common key in accordance with an illustrative embodiment. In alternative embodiments, fewer, additional, and/or different operations may be performed. Also, the use of a flow diagram is not meant to be limiting with respect to the order of operations performed. In an operation 405, the common key service receives a request for an individual's records.

In an operation 410, the common key services uses a common key to locate records related to the individual. In one embodiment, the records located may be stored in the common key system. In another embodiment, the records may be located on other systems, such as a data sharing organization system, a provider system, an MPI, or other locations where records may be stored. The common key utilized to locate or identify the records may be determined in various ways such as the methods described above with respect to FIGS. 1-3.

In an operation 415, the records located are formatted based on a format preference of the requestor. This formatting may affect the way certain information/data is presented, and may affect what information/data is presented. In other words, the system may format the delivered records form and determine which records or portions of records should actually be delivered. In an operation 420, the records located and formatted are sent to the requestor.

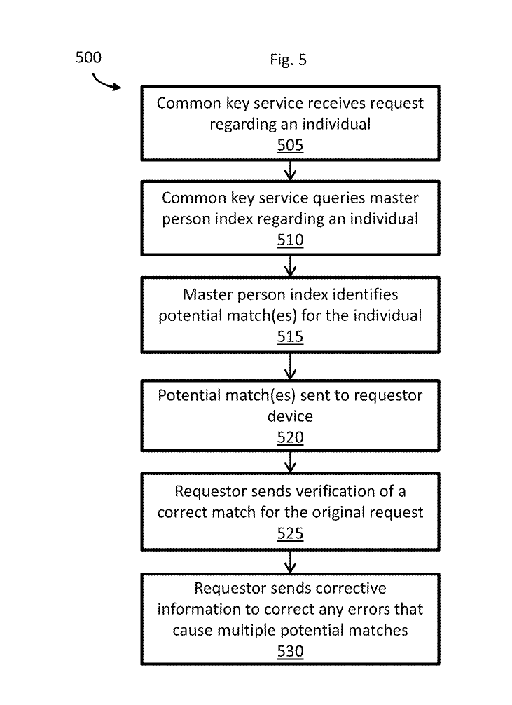

FIG. 5 is a flow diagram illustrating a method 500 for verifying potential person matches in accordance with an illustrative embodiment. In alternative embodiments, fewer, additional, and/or different operations may be performed. Also, the use of a flow diagram is not meant to be limiting with respect to the order of operations performed. In an operation 505, the common key service receives a request regarding an individual.

In an operation 510, the common key service queries an MPI regarding the individual. In an operation 515, the MPI identifies potential matches (or a single potential match) for the individual. In an operation 520, the potential match(es) are sent to the requestor device. In an operation 525, the requestor sends verification of a correct match for the original request to the common key service and/or the MPI. In other words, the requestor confirms which of the potential match(es) is the correct match. In an operation 530, the requestor may also send corrective information to correct any errors that cause multiple matches. For example, some demographic information of an individual may be stored incorrectly in the MPI such that the MPI erroneously returned that individual as a potential match. The request may, in the operation 530, correct the error to prevent future mistakes and make the MPI and the common key service more accurate and helpful. In an alternative embodiment, confirmation of a correct match and/or corrective information regarding a record may be sent from an entity or device other than the requestor. For example, the common key service or the MPI may also be able to determine a correct match from potential match(es) and correct incorrect information in a record.

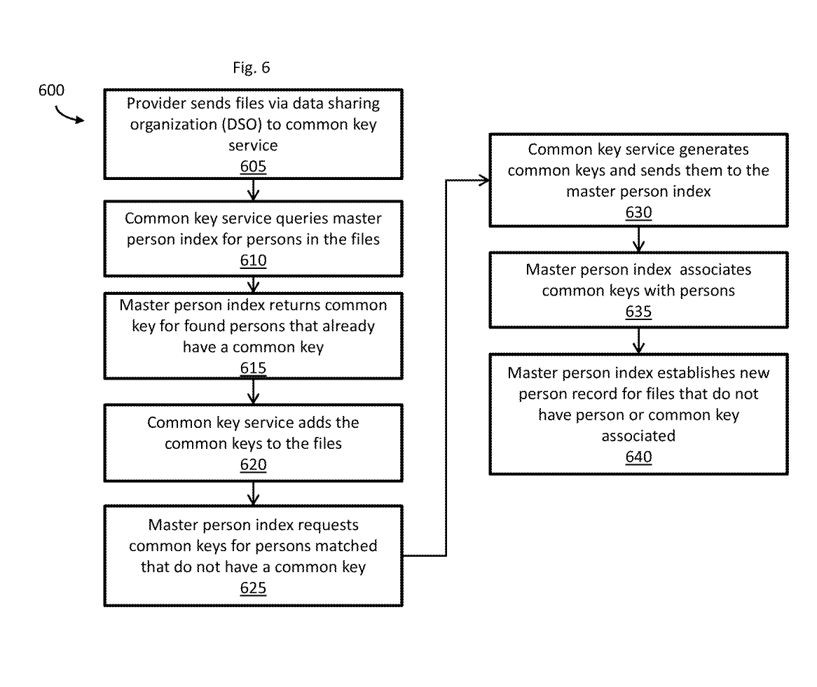

FIG. 6 is a flow diagram illustrating a method 600 for updating files using a common key service in accordance with an illustrative embodiment. In alternative embodiments, fewer, additional, and/or different operations may be performed. Also, the use of a flow diagram is not meant to be limiting with respect to the order of operations performed. In an operation 605, a healthcare provider sends files via a data sharing organization (DSO) device to a common key service.

In an operation 610, the common key service queries a master person index (MPI) for persons that match persons represented in the files sent from the DSO. In an operation 615, the MPI returns a common key for any matched individuals in the MPI database that match the persons in the files sent from the DSO. In the operation 615, the persons matched have already been assigned a common key. In an operation 620, the common key service adds the common keys attributed to the matched persons to the files.

In an operation 625, the MPI requests common keys for persons matched that do not already have a common key assigned. In an operation 630, the common key service generates common keys for those persons and sends the common keys to the MPI. In an operation 635, the MPI associates the generated common keys with the person found in the MPI but previously not yet assigned a common key.

In an operation 640, the MPI establishes a new person record for each of the persons from the files that do not yet have a matched person in the MPI or an associated common key. The method demonstrated in FIG. 6 may be utilized to intake and process large amounts of files and records that apply to many varying persons.

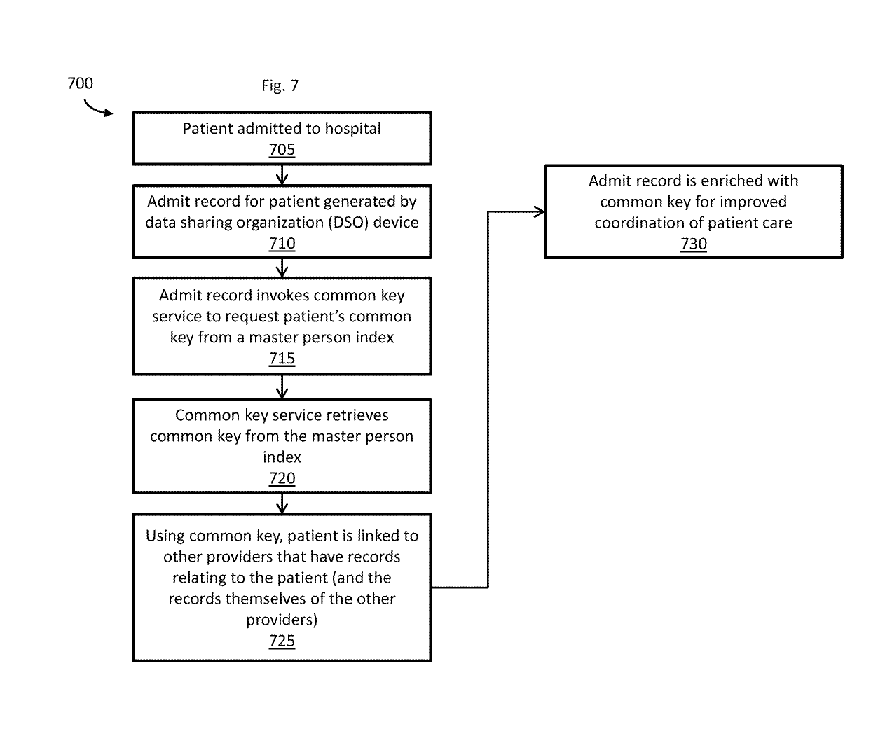

FIG. 7 is a flow diagram illustrating a method 700 for utilizing a common key service in conjunction with a patient's hospital visit in accordance with an illustrative embodiment. In alternative embodiments, fewer, additional, and/or different operations may be performed. Also, the use of a flow diagram is not meant to be limiting with respect to the order of operations performed. In an operation 705, a patient is admitted to a hospital.

In an operation 710, an admit record for the patient is generated by a data sharing organization (DSO) device. In an operation 715, the admit record and the DSO invokes a common key service to request the patient's common key from an MPI. In an operation 720, the common key service retrieves the patient's common key from the master person index. In alternative embodiments, the patient's common key may be generated similar to the common keys discussed above with respect to FIGS. 1 and 2.

In an operation 725, the common key service links the common key to link the patient to other providers that have records relating to that patient (and to the patient's records possessed by the other providers). In an operation 730, the admit record is enriched with the common key for improved coordination of patient care. In another embodiment, the admit record may also be enriched with other information, such as the linked other providers and other provider records identified in the operation 725.

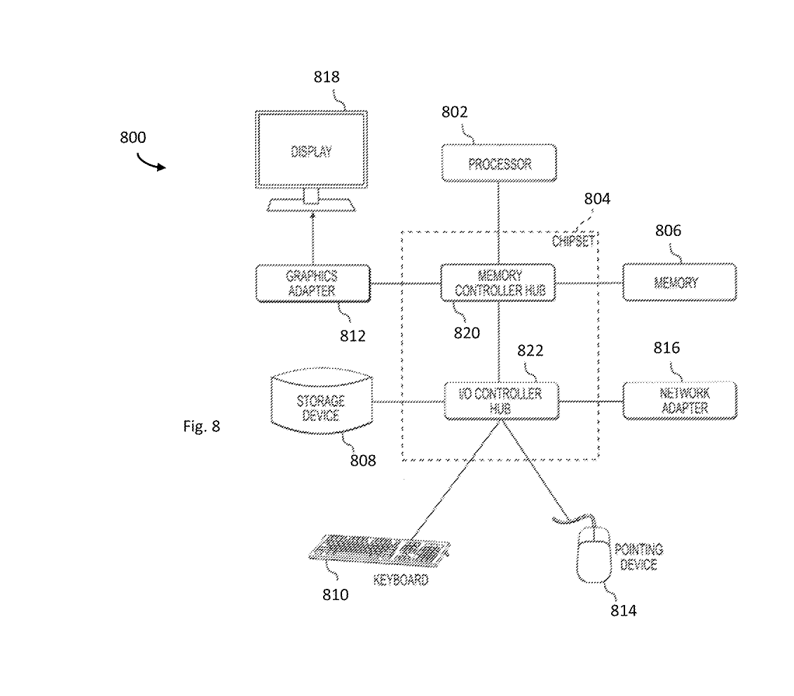

FIG. 8 is a block diagram illustrating an example computer 800 in accordance with an illustrative embodiment. In alternative embodiments, fewer, additional, and/or different components may be present. The computer 800 may be any computing machine, such as a tablet, smart phone, laptop computer, desktop computer, server, remote client device, gaming device, smart television device, wearable computer, or any combination thereof. The computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 may have different architectures.

The storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, or other type of pointing device, and is used in combination with the keyboard 810 to input data into the computer 800. The pointing device 814 may also be a gaming system controller, or any type of device used to control the gaming system. For example, the pointing device 814 may be connected to a video or image capturing device that employs biometric scanning to detect a specific user. The specific user may employ motion or gestures to command the point device 814 to control various aspects of the computer 800.

The graphics adapter 812 displays images and other information on the display 118. The network adapter 816 couples the computer system 800 to one or more computer networks.

The computer 800 is adapted to execute computer program modules for providing functionality described herein. As used herein, the term module refers to computer program logic used to provide the specified functionality. Thus, a module can be implemented in hardware, firmware, and/or software. In one embodiment, program modules are stored on the storage device 808, loaded into the memory 806, and executed by the processor 802.

The types of computers used by the entities and processes disclosed herein can vary depending upon the embodiment and the processing power required by the entity. The computer 800 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 810, graphics adapters 812, and displays 818.

The computer 800 may act as a server. The computer 800 may be clustered with other computer 800 devices to create the server. The various computer 800 devices that constitute the server may communicate with each other over a network.

As would be appreciated by one of ordinary skill in the art, the embodiments disclosed herein may be implemented on any system, network architecture, configuration, device, machine, or apparatus, and is not to be construed as being limited to any specific configuration, network, or systems, even though an example system is shown and described with respect to FIG. 8. The embodiments herein may be suitably implemented on conventional computing devices, for example, computer workstations, on Internet based applications, on optical computing devices, neural computers, biological computers, molecular computing devices, and other devices. As may be appreciated by those skilled in the art, the present invention, in short, may be implemented on any system, automaton, and/or Turing machine.

An automaton is herein described as a mechanism that is relatively self-operating and designed to follow a predetermined sequence of operations or respond to encoded instructions. A Turing machine is herein described as an abstract expression of a computing device that may be realized or implemented on an infinite number of different physical computing devices. Examples of systems, automatons and/or Turing machines that may be utilized in performing the process of the present invention include, but are not limited to: electrical computers (for example, an International Business Machines (IBM) personal computer); neuro-computers (for example, one similar to the “General Purpose Neural Computer” described in U.S. Pat. No. 5,155,802, issued to Paul H. Mueller, on Oct. 13, 1992); molecular computers (for example, one similar to the “Molecular Automata Utilizing Single or Double-Strand Oligonucleotides” described in U.S. Pat. No. 5,804,373, issued to Allan Lee Schweiter et al., on Sep. 8, 1998); biological computers (for example, one similar to the biological computer presented by Ehud Shapiro, of the Computer Science and Applied Mathematics Department at the Weizman Institute of Science (Rehovot, Israel), at the Fifth International Meeting on DNA-Based Computers); and optical computers. For purposes of simplicity, such devices hereinafter are referred to as computers, as is commonly understood in the art. But, the embodiments disclosed herein are not limited being applied to such devices and may be accomplished upon any system or collection of systems capable of providing the features and functions identified herein.

The methods described above and below with respect to FIGS. 1-7 and 9 may be performed partially or wholly on a processor, such as the one described above with regards to computer 800.

Certain of the devices shown in FIG. 8 include a computing system. The computing system includes a processor (CPU) and a system bus that couples various system components including a system memory such as read only memory (ROM) and random access memory (RAM), to the processor. The aspects disclosed herein may be suitably implemented on conventional computing devices, for example, computer workstations, on Internet based applications, on optical computing devices, neural computers, biological computers, molecular computing devices, and other devices. As may be appreciated by those skilled in the art, the aspects disclosed herein may be implemented on any system, automaton, and/or automated machine.

Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, motion detection, camera for video and photo input, and so forth. An output device can include one or more of a number of output mechanisms, such as a display screen, a printer, or speaker. In some instances, multimodal systems enable a user to provide multiple types of input to communicate with the computing system. A communications interface generally enables the computing device system to communicate with one or more other computing devices using various communication and network protocols.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

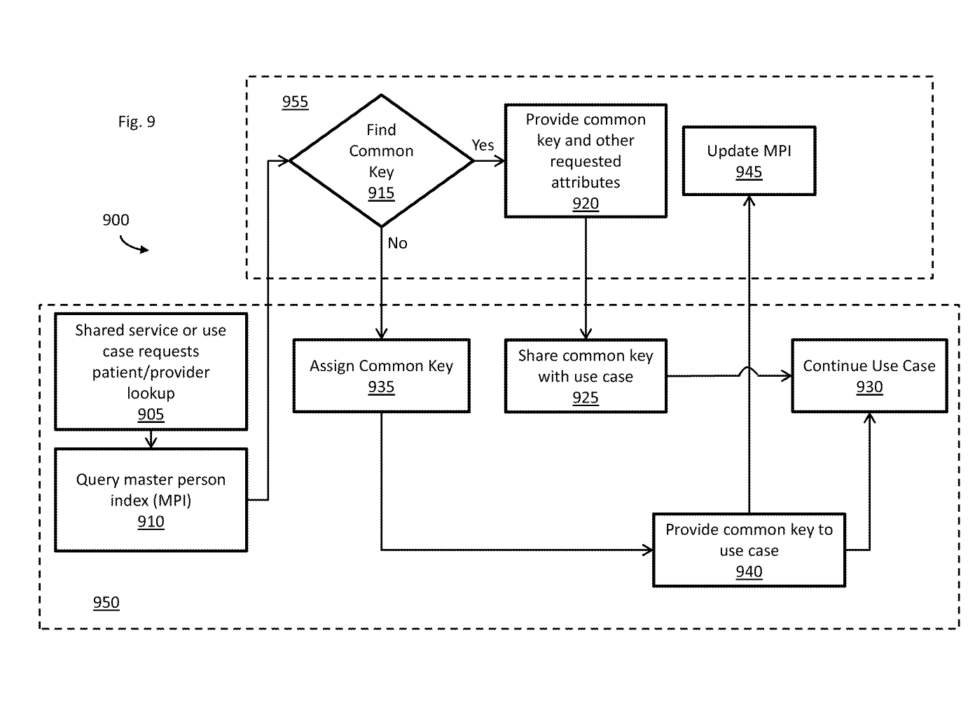

FIG. 9 is a flow diagram illustrating a method 900 for utilizing a common key service in accordance with an illustrative embodiment. In alternative embodiments, fewer, additional, and/or different operations may be performed. Also, the use of a flow diagram is not meant to be limiting with respect to the order of operations performed. The method 900 shows steps that may be performed by a master person index (MPI) 955, and steps that may be performed by a common key service 950.

In an operation 905, a shared service or use case requests a patient and/or provider lookup from the common key service 950. In an operation 910, the common key service 950 queries the MPI 955. In an operation 915, the MPI 955 determines whether the patient and/or provider has a common key. If the patient and/or provider does have a common key, the MPI 955 provides the common key and any other requested attributes (such as demographic information or other records) to the common key service 950. In an operation 925, the common key service 950 in turn provides that information and the common key to the requestor, shared service, use case, etc. In an operation 930, the common key service 950 then continues the use case, shared service, etc. In other words, the shared service, use case, etc. utilizes the provided information and/or common key for a purpose for which the information and/or common key was requested, such as obtaining or updating a record.

In an operation 935, the common key service 950 assigns a common key because the MPI 955 did not find a common key in the operation 915. In an operation 940, the generated common key is provided to the use case, shared service, requestor, etc. In an operation 945, the generated common key is provided to the MPI 955, so that the MPI 955 can be updated with the generated common key. In the operation 945, the generated common key is associated in the MPI 955 with the patient and/or provider that the common key has been generated for, such that the common key may be subsequently associated with that patient and/or provider. In the operation 930, the common key service 950 then continues the use case, shared service, etc. In other words, the shared service, use case, etc. utilizes the provided information and/or common key for a purpose for which the information and/or common key was requested, such as obtaining or updating a record.

In an illustrative embodiment, any of the operations described herein can be implemented at least in part as computer-readable instructions stored on a computer-readable medium or memory. Upon execution of the computer-readable instructions by a processor, the computer-readable instructions can cause a computing device to perform the operations.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A method according to a set of instructions stored on the memory of a computing device, the method comprising:
receiving from a data sharing organization device, by a processor of the computing device, a request to obtain or update a record associated with an individual;
determining, by the processor, a match in a master person index between the individual and an identity of the individual stored in the master person index;
determining, by the processor, that a common key identifier unique to the individual does not exist;
generating, by the processor, the common key identifier;
sending, by the processor, the common key identifier to the master person index such that the common key identifier is stored in the master person index and associated with the identity of the individual stored in the master person index; and
sending, by the processor, the common key identifier unique to the identifier to the data sharing organization device.

2. The method of claim 1, further comprising:
receiving, by the processor, a second request to obtain or update the record associated with the individual, wherein the second request is received after the request;
determining, by the processor, the match in the master person index between the individual and the identity of the individual stored in the master person index; and
determining, by the processor, the common key identifier stored in the master person index.

3. The method of claim 2, wherein the second request is received from the data sharing organization device, and further comprising sending, by the processor, the common key identifier unique to the identifier to the data sharing organization device.

4. The method of claim 2, wherein the second request is received from a second data sharing organization device, and further comprising sending, by the processor, the common key identifier unique to the identifier to the second data sharing organization device.

5. The method of claim 4, wherein the common key identifier serves to link both the request and the second request to the individual.

6. The method of claim 1, further comprising obtaining or updating, by the processor, the record associated with the individual according to the request.

7. The method of claim 6, further comprising sending, by the processor, the record to the data sharing organization device.

8. The method of claim 1, further comprising:
receiving, by the processor, a third request to obtain or update the record associated with the individual, wherein the third request comprises the common key identifier, and further wherein the third request is received after the request;
obtaining or updating, by the processor, the record according to the third request.

9. The method of claim 8, wherein the third request does not comprise information relating to the identity of the individual.

10. The method of claim 1, wherein the record is a medical record and the individual is a patient.

11. A non-transitory computer readable medium having instructions stored thereon that, upon execution by a computing device, cause the computing device to perform operations, wherein the instructions comprise:
instructions to receive from a data sharing organization device a request to obtain or update a record associated with an individual;
instructions to determine a match in a master person index between the individual and an identity of the individual stored in the master person index;
instructions to determine that a common key identifier unique to the individual does not exist;
instructions to generate the common key identifier;
instructions to send the common key identifier to the master person index such that the common key identifier is stored in the master person index and associated with the identity of the individual stored in the master person index; and
instructions to send the common key identifier unique to the identifier to the data sharing organization device.

12. The non-transitory computer readable medium of claim 11, wherein the match comprises a plurality of potential matches in the master person index such that a plurality of potential identities in the master person index is matched to the individual, and further wherein the instructions to determine the match further comprise:
instructions to send to the data sharing organization device the plurality of potential identities from the master person index; and
instructions to receive from the data sharing organization device a selected identity from of the plurality of potential identities indicating that the selected identity is a correct match, wherein a potential identity associated with the correct match is used as the identity of the individual.

13. The non-transitory computer readable medium of claim 11, wherein the instructions further comprise instructions to receive from the data sharing organization device a confirmation that the match correctly identifies the identity of the individual stored in the master person index.

14. The non-transitory computer readable medium of claim 11, wherein the instructions further comprise instructions to send the record associated with the individual to the data sharing organization device.

15. The non-transitory computer readable medium of claim 14, wherein the record associated with the individual comprises health information about the individual assembled from at least primary care physician records, care coordinator records, medical specialist records, hospital records, insurance information, billing information, or demographic information.

16. An apparatus comprising:
a memory;
a processor coupled to the memory; and
a first set of instructions stored on the memory and configured to be executed by the processor, wherein the processor is configured to:
receive from a data sharing organization device, a request to obtain or update a record associated with an individual;
determine a match in a master person index between the individual and an identity of the individual stored in the master person index;
determine that a common key identifier unique to the individual does not exist;
generate the common key identifier;
send the common key identifier to the master person index such that the common key identifier is stored in the master person index and associated with the identity of the individual stored in the master person index; and
send the common key identifier unique to the identifier to the data sharing organization device.

17. The apparatus of claim 16, wherein the processor is further configured to:
provide the record to the data sharing organization device;
format the record based on a preference of the data sharing organization device.

18. The apparatus of claim 16, wherein the match is determined based on demographic information of the individual and the identity stored in the master person index, such that similar demographic information between the individual and the identity yields the match.

19. The apparatus of claim 16, wherein when the match is not determined, the processor is further configured to establish a new identity in the master person index.

20. The apparatus of claim 19, wherein the processor is further configured to establish a new common key identifier for the new identity.
